(19) United States
(12) Patent Application Publication
(10) Pub. No.: US 2011/0160887 A1
(43) Pub. Date: Jun. 30, 2011

(54) INFORMATION GENERATING APPARATUS, INFORMATION GENERATING METHOD AND INFORMATION GENERATING PROGRAM

(75) Inventors: Hiroyuki Ishihara, Kanagawa-ken (JP); Minoru Yoshida, Kanagawa-ken (JP)

(73) Assignee: PIONEER CORPORATION, Kanagawa (JP)

(21) Appl. No.: 13/060,222

(22) PCT Filed: Aug. 20, 2008
(86) PCT No.: PCT/JP2008/064832

§ 371 Date: Feb. 22, 2011

(51) Int. Cl. G06F 17/00

(52) U.S. Cl. 700/94

(57) ABSTRACT

It is possible to further improve an accuracy of detecting a sound producing position in a musical composition and enhancing a rate of detecting a type of a musical instrument than ever before. There is provided a sound producing position detecting part 3 which, when a sound producing position of a musical instrument playing a musical composition is detected by using a difference value of a residual power value obtained by LPC-analyzing a musical composition data Sin corresponding to the musical composition, uses a variable threshold value for detection based on a speed (tempo) of the musical composition.

### TECHNICAL FIELD

The present invention relates to the technical field of an information generating apparatus, an information generating method and an information generating program. More specifically, it relates to the technical field of an information generating apparatus, an information generating method and an information generating program for generating a sound producing signal indicating a sound producing position used to detect a type or the like of a musical instrument playing a musical composition.

### BACKGROUND ART

In recent years, like a so-called home server or portable audio device, there is widely used a system in which many items of musical composition data corresponding to musical compositions are electronically recorded and reproduced for enjoying music. For enjoying the music, it is desirable to rapidly retrieve a desired musical composition from among many musical compositions.

One of various retrieving methods for the retrieval is a method for retrieving a musical composition by using a musical instrument used for playing the musical composition as a keyword such as “musical composition containing piano playing” or “musical composition containing guitar playing”, for example. In order to realize the retrieving method, it is necessary to rapidly and accurately detect a type of musical instrument playing a musical composition recorded in the home server or the like.

On the other hand, for detecting the type of the musical instrument, sound producing positions of the sounds of the musical composition are detected, respectively, and the musical composition signals detected at the sound producing positions are analyzed to specify the type of the musical instrument sound-produced from the sound producing position.

The “sound producing position” refers to a timing at which one sound is produced by its musical instrument in the musical composition configured with multiple consecutive sounds on a temporal axis. Specifically, for example, it refers to, in the case of the piano, a timing at which a player's finger presses a key of the piano and accordingly a corresponding hammer hits a string so that a corresponding sound is produced, or in the case of the guitar, a timing at which a string is picked by a player's finger and accordingly a corresponding sound is produced.

There are the following conventional technique for detecting the sound producing position from a signal corresponding to a musical composition:

(1) Method for detecting a sound producing position by utilizing a temporal change in an acoustic power value of a sound of the signal (see Patent Literature 1),

(2) Method for detecting a sound producing position by utilizing a temporal change in linear predictive power value obtained by analyzing a sound of the signal by the linear predictive coding (LPC) method, or

(3) Method for detecting a sound producing position by obtaining a frequency gravity center of a sound of the signal by Fourier transform method and utilizing a change in frequency gravity center (see Non-Patent Literature 1).

The LPC method is a method for, assuming that a musical composition signal corresponding to a musical composition is an output of an articulation filter having an all-pole transfer function, modeling a spectrum density function of the musical composition signal and thereby efficiently obtaining an outline of the spectrum of the musical composition signal using the so-called linear predictive concept.
Patent Literature 1: Patent No. 2966460 Publication
Non-Patent Literature 1: P. Masri, Computer Modeling of Sound for Transformation and Synthesis of Musical Signal, PhD Thesis, University of Bristol, December 1996

### DISCLOSURE OF THE INVENTION

### Problem to be Solved by the Invention

However, in the conventional technique described in the aforementioned patent literature or non-patent literature, a speed (so-called “tempo”) of a musical composition to be analyzed is not considered at all. Consequently, in the above conventional technique, there is a problem that an accuracy of detecting a sound producing position of a musical composition decreases and thus an accuracy (detection rate) of detecting a type of a musical instrument also decreases.

The present invention has been made in terms of the above problem, and one exemplary object is to provide an information generating apparatus, an information generating method and an information generating program capable of further improving an accuracy of detecting a sound producing position in a musical composition and enhancing a rate of detecting a type of a musical instrument than ever before.

### Means for Solving the Problem

In order to solve the above problem, the invention according to claim 1 relates to an information generating apparatus for generating type detection information used to detect a type of a musical instrument playing a musical composition, comprising:

a dividing unit which divides a musical composition signal corresponding to the musical composition into frame signals per preset unit time;

a power value calculating unit which performs a linear predictive analyzing processing on the divided frame signals and calculating a power value of a residual signal according to the linear predictive analyzing processing per frame signal;

a power value difference detecting unit which calculates a difference between the power value corresponding to one frame signal and the power value corresponding to the other frame signal position immediately before the one frame signal in the musical composition signal;

a threshold value calculating unit which calculates a threshold value for the difference used to detect a sound producing position of the musical instrument in the musical composition based on the calculated difference;

a sound producing position detecting unit which compares the calculated threshold value with each difference corresponding to each frame signal, and detects that the sound producing position is contained in a section of the frame signal having the larger difference than the threshold value; and

a generating unit which generates the type detection information corresponding to the section containing the sound producing position based on the detected sound producing position.

In order to solve the above problem, the invention according to claim 10 relates to an information generating method for generating type detection information used to detect a type of a musical instrument playing a musical composition, comprising:

a process of dividing a musical composition signal corresponding to the musical composition into frame signals per preset unit time;

a process, of calculating a power value, of performing a linear predictive analyzing processing on the divided frame signals and calculating a power value of a residual signal according to the linear predictive analyzing processing per frame signal;

a process, of detecting a power value difference, of calculating a difference between the power value corresponding to one frame signal and the power value corresponding to the other frame signal positioned immediately before the one frame signal in the musical composition signal;

a process, of calculating a threshold value, of calculating a threshold value for the difference used to detect a sound producing position of the musical instrument in the musical composition based on the calculated difference;

a process, of detecting a sound producing position, of comparing the calculated threshold value with each difference corresponding to each frame signal, and detecting that the sound producing position is contained in a section of the frame signal having the larger difference than the threshold value; and

a process of generating the type detection information corresponding to the section containing the sound producing position based on the detected sound producing position.

In order to solve the above problem, the invention according to claim 11 relates to an information recording medium in which an information generating program causing a computer to function as the information generating apparatus according to claim 1 is computer-readably recorded.

### BRIEF DESCRIPTION OF THE DRAWINGS

FIG. 1 is a block diagram showing a schematic structure of a musical composition reproducing apparatus according to an embodiment;

FIG. 2 is a block diagram showing a detailed structure of a sound producing position detecting part according to the embodiment;

FIG. 3 is a flowchart showing an entire sound producing position detecting processing according to the embodiment;

FIG. 4 is a flowchart showing a threshold value calculating processing according to the embodiment;

FIG. 5 is a flowchart showing a detailed sound producing position correcting processing according to the embodiment;

FIGS. 6A to 6F are diagrams schematically showing the sound producing position correcting processing according to the embodiment, where FIGS. 6A and 6B are timing charts showing the first example and FIGS. 6C to 6F are timing charts showing the second example;

FIG. 7 is a flowchart showing an entire sound producing position detecting processing according to a variant;

FIG. 8 is a flowchart showing a threshold value calculating processing according to the variant; and

FIGS. 9A and 9B are diagrams showing effects of the present invention, where FIG. 9A is the first diagram exemplifying an accuracy of a conventional sound producing position detecting processing and FIG. 9B is the second diagram exemplifying the accuracy of the conventional sound producing position detecting processing.

### DESCRIPTION OF REFERENCE NUMERALS

1: Data input part
2: Single musical instrument's sound section detecting part
3: Sound producing position detecting part
3A: Sound producing characteristic amount calculating part
3B: Threshold value judging part
3C: Sound producing position correcting part
4: Characteristic amount calculating part
5: Comparing part
6: Condition input part
7: Result storing part
8: Reproducing part
10: Threshold value updating part
D: Musical instrument detecting part
S: Musical composition reproducing apparatus
DB: Model accumulating part

### BEST MODES FOR CARRYING OUT THE INVENTION

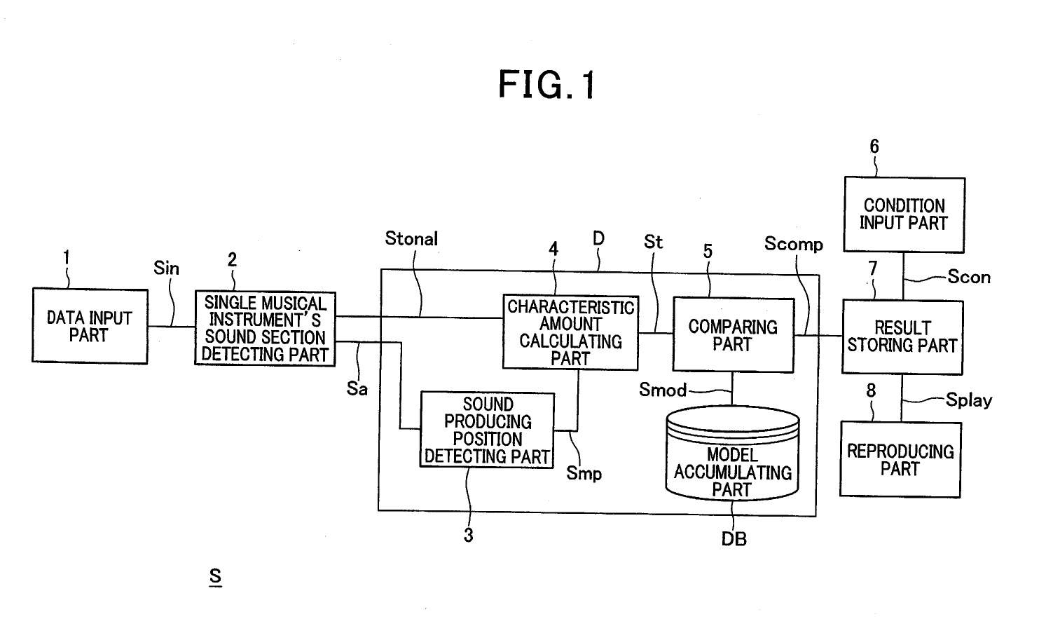

The best modes for carrying out the present invention will be described below with reference to FIGS. 1 to 6. The embodiment and variant described later are the cases in which the present invention is applied to a musical composition reproducing apparatus such as musical DVD (Digital Versatile Disc) or musical server for retrieving a musical composition being played by a desired musical instrument from a recording medium having many musical compositions recorded therein and reproducing the same.

### (A) Embodiment

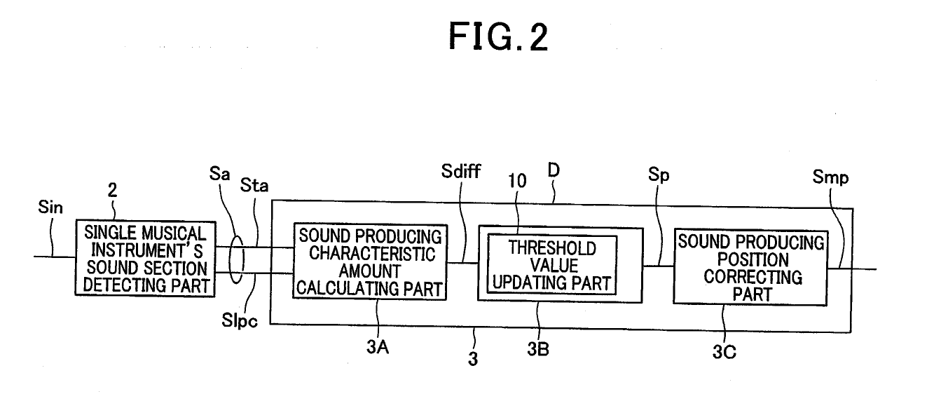

At first, a structure of a musical composition reproducing apparatus according to the embodiment will be described with reference to FIG. 1 and FIG. 2. FIG. 1 is a block diagram showing an entire structure of the musical composition reproducing apparatus according to the embodiment and FIG. 2 is a block diagram showing a detailed structure of a sound producing position detecting part according to the embodiment.

As shown in FIG. 1, a musical composition reproducing apparatus S according to the embodiment is configured with a data input part 1, a single musical instrument's sound section detecting part 2 as dividing means and amplitude calculating means, a musical instrument detecting part D, a condition input part 6 made of operation button or keyboard and mouse, a result storing part 7 made of hard disc drive, a display part (not shown) made of liquid crystal display, and a reproducing part 8 made of speaker (not shown). The musical instrument detecting part D is configured with a sound producing position detecting part 3 as sound producing position detecting means, generating means and power value difference detecting means, a characteristic amount calculating part 4, a comparing part 5 and a model accumulating part DB.

The operations will be described below.

Musical composition data corresponding to a musical composition to be subjected to a musical instrument detecting processing according to the embodiment is output from the musical DVD or the like and is output as musical composition data Sin to the single musical instrument's sound section detecting part 2 via the data input part 1.

Thereby, the single musical instrument's sound section detecting part 2 extracts, from the entire original musical composition data Sin, the musical composition data Sin belonging to a single musical instrument's sound section which is a temporal section of the musical composition data Sin which can be aurally considered as configured with either a single musical instrument's sound or single singer's voice by the method described later. Then, the extraction result is output as single musical instrument's sound data Stonal to the musical instrument detecting part D. The single musical instrument's sound section includes not only a temporal section in which a musical instrument such as piano or guitar is being played solo but also a temporal section in which the guitar is being played mainly while a drum is accompanying with small rhythm.

Additionally, the single musical instrument's sound section detecting part 2 uses a processing of analyzing the musical composition data Sin by the conventional method such as LPC method to output the analysis data Sa as the result of the analyzed musical composition data Sin to the musical instrument detecting part D. The analysis data Sa includes a residual value Slpc which is a LPC residual value calculated by the processing of analyzing the musical composition data Sin using the LPC method and single musical instrument's sound section information Sta indicating the single musical instrument's sound section described later.

Then, the musical instrument detecting part D detects a musical instrument which is playing a musical composition in the temporal section corresponding to the single musical instrument's sound data Stonal based on the single musical instrument's sound data Stonal and the analysis data Sa input from the single musical instrument's sound section detecting part 2, and generates a detection result signal Scomp indicating the detected result and outputs it to the result storing part 7.

Thereby, the result storing part 7 stores the musical instrument detection result output as the detection result signal Scomp together with the information indicating a musical composition title and a player name of the musical composition corresponding to the original musical composition data Sin in a nonvolatile manner. The information indicating the musical composition title and the player name is obtained via a network (not shown) in correspondence to the musical composition data Sin to be subjected to the musical instrument detection.

Next, the condition input part 6, which is operated by a user who desires to reproduce a musical composition, generates condition information Scon indicating a retrieval condition of a musical composition including a user-desired musical instrument name in response to the operation and outputs it to the result storing part 7.

The result storing part 7 compares a musical instrument indicated by the detection result signal Scomp per musical composition data Sin output from the musical instrument detecting part D with a musical instrument included in the condition information Scon. Thus, the result storing part 7 generates reproduction information Splay including the musical composition name and the player name of the musical composition corresponding to the detection result signal Scomp including a musical instrument matching with the musical instrument included in the condition information Scon, and outputs it to the reproducing part 8.

Finally, the reproducing part 8 displays contents of the reproduction information Splay on the display part (not shown). Thus, when a musical composition to be reproduced by the user (a musical composition including a user-desired musical instrument playing portion) is selected, the reproducing part 8 acquires the musical composition data Sin corresponding to the selected musical composition via a network (not shown) or the like and reproduces/outputs it.

Next, the operations of the musical instrument detecting part D will be described with reference to FIG. 1.

As shown in FIG. 1, the analysis data Sa input into the musical instrument detecting part D is output to the sound producing position detecting part 3 and the single musical instrument's sound data Stonal is output to the characteristic amount calculating part 4.

The sound producing position detecting part 3 detects a timing at which the musical instrument whose playing is detected as the single musical instrument's sound data Stonal produces a sound corresponding to one musical note in the musical composition corresponding to the single musical instrument's sound data Stonal, and a time for which the sound is being produced with the timing as the starting point, respectively, based on the single musical instrument's sound section information Sta and the residual value Slpc included in the analysis data Sa by the method described later. The detection result is output as a sound producing signal Smp to the characteristic amount calculating part 4.

Thus, the characteristic amount calculating part 4 calculates the acoustic characteristic amount of the single musical instrument's sound data Stonal per sound producing position indicated by the sound producing signal Smp by the conventionally-known characteristic amount calculating method, and outputs it as a characteristic amount signal St to the comparing part 5. At this time, the characteristic amount calculating method needs to correspond to a model comparing method in the comparing part 5. The characteristic amount calculating part 4 generates a characteristic amount signal St per sound (sound corresponding to one musical note) in the single musical instrument's sound data Stonal.

Then, the comparing part 5 compares the acoustic characteristic amount per sound indicated by the characteristic amount signal St with an acoustic model per musical instrument which is accumulated in the model accumulating part DB and is output as a model signal Smod to the comparing part 5.

Data corresponding to a musical instrument's sound model using, for example, HMM (Hidden Markov Model) is accumulated per musical instrument in the model accumulating part DB and is output as a model signal Smod per musical instrument's sound model to the comparing part 5.

Then, the comparing part 5 performs a processing of recognizing a musical instrument's sound per sound by using, for example, so-called Viterbi algorithm. More specifically, a log likelihood of the characteristic amount per sound relative to a musical instrument's sound model is calculated and the musical instrument's sound model whose log likelihood is maximum is assumed as a musical instrument's sound model corresponding to a musical instrument playing the sound so that the detection result signal Scomp indicating the musical instrument is output to the result storing part 7. In order to exclude a recognition result having low reliability, there may be configured such that a threshold value is set for the log likelihood and a recognition result with a log likelihood having a threshold value or less is excluded.

Next, the operations of the single musical instrument's sound section detecting part 2 will be described more specifically.

The single musical instrument's sound section detecting part 2 according to the embodiment, though detailed below, detects the single musical instrument's sound section on the principle that a so-called (single) voice generating mechanism model is applied to a musical instrument generating mechanism model.

In other words, typically, in a struck string instrument such as piano or a plucked string instrument such as guitar, when a vibration is given to a string as sound source, a sound power immediately attenuates and then ends with resonance. Consequently, in the struck string instrument or plucked string instrument, a linear predictive (LPC) residual power value calculated by the formula of residual power value=(corresponding residual value Slpc)² using the residula value Slpc is small (the linear predictive (LPC) residual power value is simply called residual power value below).

To the contrary, when multiple musical instruments are being played at the same time, the musical instrument generating mechanism model to which the above voice generating mechanism model is applied cannot be adapted, and thus the residual power value becomes larger.

The single musical instrument's sound section detecting part 2 judges that the temporal section of the musical composition data Sin having a residual power value larger than the experimentally-preset threshold value of the residual power value is not the single musical instrument's sound section of a struck string instrument or plucked string instrument based on the magnitude of the residual power value in the musical composition data Sin, and ignores it. To the contrary, it is judged that the temporal section of the musical composition data Sin having a residual power value not exceeding the threshold value is the single musical instrument's sound section. Thus, the single musical instrument's sound section detecting part 2 extracts the musical composition data Sin belonging to the temporal section which is judged to be the single musical instrument's sound section, and outputs it as the single musical instrument's sound data Stonal to the musical instrument detecting part D.

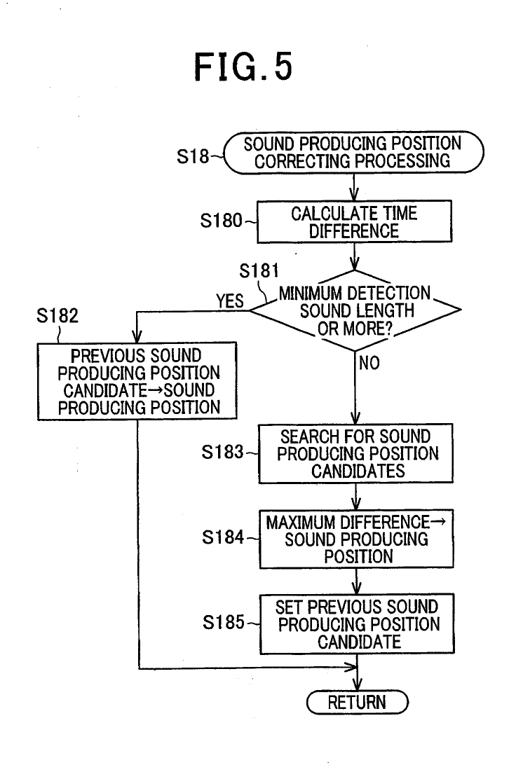

The operations of the single musical instrument's sound section detecting part 2 described above correspond to the contents of the international application having the application number PCT/JP2007/55899 by the applicant, and more specifically the techniques described in FIG. 5 of the patent application and the paragraphs [0017] to [0081] of the specification.

Along with this, the single musical instrument's sound section detecting part 2 divides the musical composition data Sin into frames each having the following preset information amount, generates the single musical instrument's sound section information Sta indicating the temporal section judged to be the single musical instrument's sound section per frame, configures the analysis data Sa together with the residual value Slpc, and outputs it to the musical instrument detecting part D.

Specifically, the single musical instrument's sound section information Sta includes start timing information indicating a start timing of a temporal section judged to be the single musical instrument's sound section, and end timing information indicating an end timing of the temporal section.

At this time, the start timing information and the end timing information indicate which samples among the samples constituting one musical composition are a start sample and an end sample of the single musical instrument's sound section.

More specifically, for example, it is assumed that in a 10-second musical composition, the start timing of the single musical instrument's sound section is three seconds from the beginning and the end timing of the section is seven seconds from the beginning. In this case, the start sample information is expressed by start sample information=fs×3 samples, where the sampling frequency in the musical composition data Sin is assumed as “fs”, while the end sample information is expressed by end sample information=fs×7 samples. The temporal section of the “fs×7−fs×3” samples is the single musical instrument's sound section, and the single musical instrument's sound section detecting part 2 divides the section into frames as described above. Thus, one single musical instrument's sound section is configured with one or multiple frames. The information amount per frame is 512 samples (11.6 msec in time) when the sampling frequency is 44.1 kHz.

Next, the detailed structure and operations of the sound producing position detecting part 3 will be described more specifically with reference to FIG. 2.

As shown in FIG. 2, the sound producing position detecting part 3 into which the single musical instrument's sound section information Sta and the residual value Slpc are input as the analysis data Sa is configured with a sound producing characteristic amount detecting part 3A, a threshold value judging part 3B including a threshold value updating part 10 as threshold value calculating means, and a sound producing position correcting part 3C.

With the configuration, the sound producing characteristic amount calculating part 3A calculates a differential value relative to a residual power value (residual power value calculated using the residual value Slpc of the immediately previous frame) of the single musical instrument's sound data Stonal in the immediately-previous frame per residual power value corresponding to the single musical instrument's sound data Stonal corresponding to each frame based on the single musical instrument's sound section information Sta and the residual value Slpc, and outputs it as a differential value Sdiff to the threshold value judging part 3B.

Thereby, the threshold value judging part 3B compares a threshold value of the differential value Sdiff sequentially updated by the threshold value updating part 10 as described later (which is simply called threshold value below) with the differential value Sdiff, and when the differential value Sdiff is the threshold value or more, judges that the a sound producing position is present within a period corresponding to the frame corresponding to the differential value Sdiff, and assumes the frame as sound producing position candidate. Thereafter, candidate data Sp indicating the sound producing position candidate is generated and output to the sound producing position correcting part 3C.

Finally, the sound producing position correcting part 3C extracts a sound producing position candidate which is estimated to include a true sound producing position through the operation described later from the sound producing position candidates indicated by multiple items of candidate data Sp, and outputs the extracted sound producing position candidate as the sound producing signal Smp to the characteristic amount calculating part 4.

As is clear from the operations of the threshold value judging part 3B and the sound producing position correcting part 3C described above, the minimum unit in detecting a sound producing position according to the embodiment is a frame. In other words, the sound producing position detecting part 3 detects a sound producing position with one fram as minimum unit in time, and outputs the result as the sound producing signal Smp.

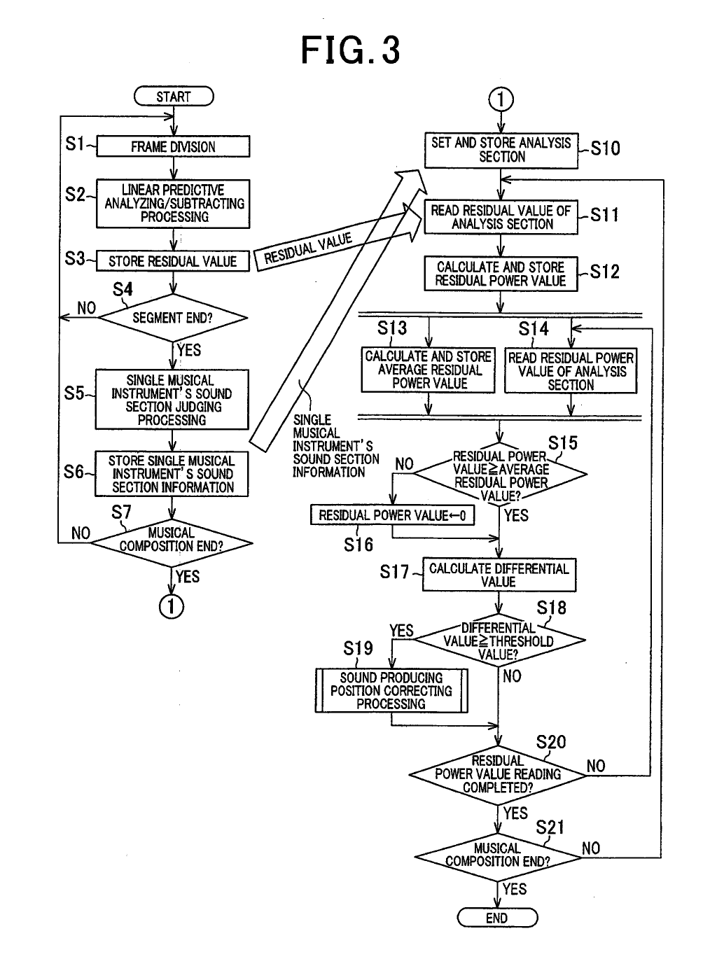

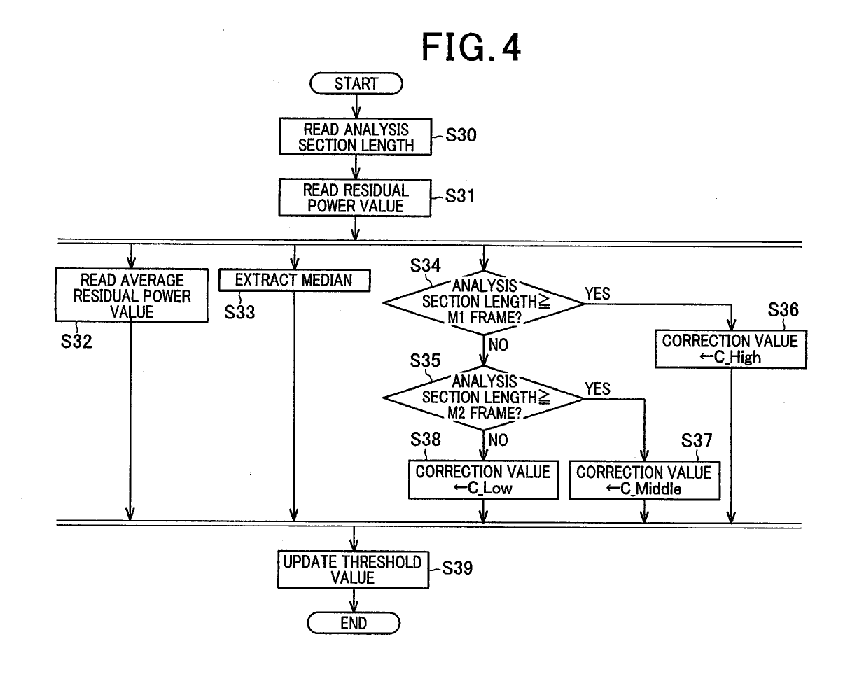

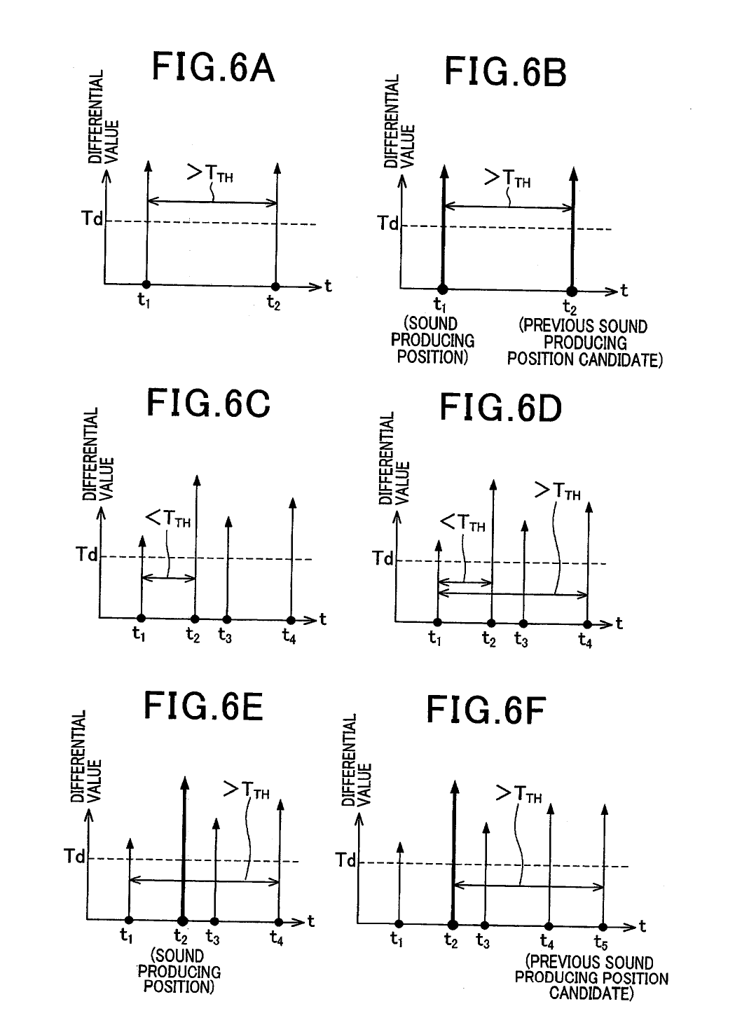

Then, the sound producing position detecting operation by the sound producing position detecting part 3 according to the embodiment will be described in more detail with reference to FIGS. 3 to 6. FIG. 3 is a flowchart showing the entire sound producing position detecting operation together with the operation of the single musical instrument's sound section detecting part 2, FIG. 4 is a flowchart showing the threshold value calculating operation performed by the threshold value updating part 10, and FIG. 5 is a flowchart showing the details of the sound producing position correcting operation performed by the sound producing position correcting part 3C. FIG. 6 is a diagram schematically showing the sound producing position correcting operation.

### (I) Entire Sound Producing Position Detecting Operation

At first, the entire sound producing position detecting operation will be described with reference to FIG. 3. In FIG. 3, the operations of the single musical instrument's sound section detecting part 2 are indicated as steps S1 to S7 and the operations of the sound producing position detecting part 3 are indicated as steps S10 to S21.

As shown in FIG. 3, in the sound producing position detecting operation according to the embodiment, at first the single musical instrument's sound section detecting part 2 divides the input musical composition data Sin into the frames (step S1) and performs a linear predictive analyzing processing on each frame for each item of musical composition data Sin contained in the frames (step S2).

Then, the single musical instrument's sound section detecting part 2 subtracts the result of the linear predictive analyzing processing from the original musical composition data Sin of the corresponding frame and calculates the residual value according to the embodiment (the residual value on which the calculation of the residual power value is based) Slpc for each frame. Thereafter, the calculated residual value Slpc is temporarily stored in a memory (not shown) (step S3).

Next, the single musical instrument's sound section detecting part 2 confirms whether the operations of steps S1 to S3 have been completed for the entire segment configured of multiple frames (step S4). The concept of segment is similar to the conventional one like the concept of frame.

When an unprocessed frame for the operations of steps S1 to S3 is present within the target segment in the judgment of step S4 (step S4; NO), the processing returns to step S1 for performing the operations of steps S1 to S3 on the musical composition data Sin contained in the unprocessed frame.

On the other hand, when the operations of steps S1 to S3 have been performed on all the frames within the target segment in the judgment of step S4 (step S4; YES), the single musical instrument's sound section detecting part 2 performs an operation of detecting a single musical instrument's sound section on the musical composition data Sin within one segment by the above method (step S5), and temporarily stores the result as single musical instrument's sound section information Sta in the memory (not shown) (step S6).

Thereafter, the single musical instrument's sound section detecting part 2 confirms whether the operations of steps S1 to S6 have been performed on all the musical composition data Sin corresponding to one musical composition (step S7), and when the operations of steps S1 to S6 have not been terminated for all the data (step S7; NO), the processing returns to step S1 for performing the operations of steps S1 to S6 on the remaining musical composition data Sin.

On the other hand, when the operations of steps S1 to S6 have been performed on all the data in the judgment of step S7 (step S7; YES), the operations by the single musical instrument's sound section detecting part 2 are terminated and then the processing proceeds to the operations by the sound producing position detecting part 3 (steps S10 to S21).

In other words, at first the residual value per frame which is stored in the memory as a result of the operation of step S3 is sequentially output as the residual value Slpc to the sound producing characteristic amount detecting part 3A in the sound producing position detecting part 3. The single musical instrument's sound section information Sta per segment which is stored in the memory as a result of the operation of step S6 is also sequentially output.

Then, the sound producing characteristic amount detecting part 3A having acquired the data initially reads the single musical instrument's sound section information Sta output from the single musical instrument's sound section detecting part 2, and sets an analysis section which is the section of the musical composition data Sin for which the sound producing position is to be detected (step S10). Then, the sound producing characteristic amount detecting part 3A reads the residual value Slpc corresponding to each frame contained in the analysis section among the residual values Slpc output from the single musical instrument's sound section detecting part 2 (step S11).

A specific length of the analysis section according to the processing of step S10 is set by the preset conventional method using timing information and time information contained in the single musical instrument's sound section information Sta. In the operation of step S10, a frame to be contained in the analysis section is set. The threshold value is set to be variable as described later according to the length of the analysis section.

When the residual value Slpc corresponding to the analysis section is read (step S11), the sound producing characteristic amount detecting part 3A uses the residual values Slpc per read frames (multiple frames belonging to one analysis section) to calculate a residual power value per frame, and temporarily stores the obtained residual power value in the memory (not shown) (step S12). Then, the sound producing characteristic amount detecting part 3A calculates an average residual power value which is obtained by averaging the calculated residual power values for all the respective frames contained in one analysis section, and temporarily stores it in the memory (step S13).

Along with the processing of step S13, the sound producing characteristic amount detecting part 3A reads the residual power value per frame calculated by the operation of step S12 from the memory (not shown) (step S14), and compares the read residual power value with the average residual power value calculated by the operation of step S13 (step S15). Then, for the frame having the residual power value less than the average residual power value (step S15; NO), the sound producing characteristic amount detecting part 3A sets the residual power value for the frame at “0” (step S16), and proceeds to the operation of subsequent step S17.

To the contrary, for the frame having the residual power value equal to or more than the average residual power value in the judgment of step S15 (step S15; YES), the sound producing characteristic amount detecting part 3A calculates a differential value between the residual power value corresponding to the frame and the residual power value corresponding to a frame positioned immediately before the frame (step S17), and outputs it as the differential value Sdiff to the threshold value judging part 3B.

Next, the threshold value judging part 3B having received the value compares the threshold value sequentially updated by the threshold value updating part 10 as described later with the obtained differential value Sdiff (step S18). Then, when the differential value Sdiff is the threshold value or more at that time (step S18; YES), the threshold value judging part 3B assumes the frame corresponding to the differential value Sdiff as a sound producing position candidate, and generates candidate data Sp indicating the sound producing position candidate and outputs it to the sound producing position correcting part 3C.

Since the start sample information of the single musical instrument's sound section is previously found as described above, the sound producing time as the sound producing position candidate is calculated by adding the number corresponding to the frame number detected as the sound producing position (more specifically, “number of frame detected as the sound producing position−1” samples) to a value of a starting point with a value of the start sample as the starting point. In other words,

sound producing time as sound producing position candidate=start sample value (number)+{(number of frame detected as sound producing position−1) frames×number of samples for one frame}/sampling frequency fs is assumed.

For example, when the frames detected as the sound producing positions are the second frame and the fifth frame, assuming that the sampling frequency is 44.1 kHz, one frame has 512 samples, and further the start sample value is “1”,

the sound producing time corresponding to the second frame is expressed as the sound producing time=[1+{(2−1) frame×512}]/44100=22.6 microseconds.

In other words, the timing at which 22.6 microseconds have elapsed from the start of the single musical instrument's sound section is the sound producing time corresponding to the second frame. On the other hand, the sound producing time corresponding to the fifth frame is expressed by the sound producing time=[1+{(5−1)−frames×512}]/44100=46.4 microseconds.

In other words, the timing at which 46.4 microseconds have elapsed since the start of the single musical instrument's sound section is the sound producing time corresponding to the fifth frame.

Next, the sound producing position correcting part 3C extracts a sound producing position candidate estimated to include a true sound producing position based on the sound producing times which are the sound producing position candidates indicated by multiple items of candidate data Sp corresponding to the analysis section, and outputs the extracted sound producing position candidate as the sound producing signal Smp to the characteristic amount calculating part 4 (step S19), and proceeds to the operation of step S20 described later.

On the other hand, when the differential value Sdiff is less than the threshold value in the judgment of step S18 (step S18; NO), the frame corresponding to the differential value Sdiff is not assumed as the sound producing position candidate, and then the threshold value judging part 3B confirms whether the operations of steps S14 to S19 have been performed on all the frames contained in one analysis section set in step S10 (step S20). When the operations of steps S14 to S19 have not been terminated for all the frames (step S20; NO), the threshold value judging part 3B returns to step S14 for performing the operations of steps S14 to S19 on the remaining frames in the analysis section.

On the other hand, when the operations of steps S14 to S19 have been performed on all the frames in the judgment of step S20 (step S20; YES), the threshold value judging part 3B then confirms whether the operations of steps S10 to S20 have been performed on all the musical composition data Sin corresponding to one musical composition (step S21), and when the operations of steps S10 to S20 have not been terminated for all the data (step S21; NO), returns to step S10 for performing the operations of steps S10 to S20 on the remaining musical composition data Sin in the musical composition.

On the other hand, when the operations of steps S10 to S20 have been performed on all the musical composition data Sin in one musical composition in the judgment of step S21 (step S21; YES), the threshold value judging part 3B terminates the operations of the threshold value judging part 3B and the threshold value updating part 10.

### (II) Operations of Threshold Value Updating Part

Next, the operations of the threshold value updating part 10 according to the embodiment will be described in more detail with reference to FIG. 4.

As shown in FIG. 4, each time the operation of reading a residual power value (step S14 of FIG. 3) is started in the sound producing position detecting part 3 for a new frame (the new frame will be called target frame), the threshold value updating part 10 according to the embodiment first reads an analysis section length set by the operation of step S10 in FIG. 3 (step S30). Next, the threshold value updating part 10 reads the residual power value stored in step S12 of FIG. 3 for ±N frames about the target frame (step S31). The parameter N indicating the number of frames read by the operation of step S31 (that is, the parameter N for setting a section for calculating a median of the residual power values described later) is a parameter preset based on a minimum detection sound length, for example.

Next, the threshold value updating part 10 performs the operation of reading an average residual power value obtained by the operation of step S13 in FIG. 3 (step S32), the operation of extracting a median of the residual power values for ±N frames including the target frame (step S33), and the operation of setting a correction value of the threshold value depending on the analysis section length (steps S34 to S48) in parallel, and then proceeds to the operation of step S39 described later.

The operation of calculating the median according to the operation of step S33 is specifically the operation of extracting a residual power value positioned on the center of the time series from the residual power values for ±N frames including the target frame.

In the operation of setting a correction value, the threshold value updating part 10 confirms whether the analysis section length is set at the preset number of frames M1 or more (step S34), and when the length is set at the M1 frames or more (step S34; YES), assumes the correction value as the value “C_High” preset when the analysis section length is set at M1 (M1>1) frames or more (step S36). On the other hand, when the analysis section length is not set at M1 frames or more in the judgment of step S34 (step S34; NO), the threshold value updating part 10 confirms whether the analysis section length is set at the number of frames M2 which is preset and is between “1” and M1 (step S35), and when the length is set at M2 frames or more (step S35; YES), assumes the correction value as the value “C_Middle” preset when the analysis section length is set between M2 frames and M1 frames (step S37). On the other hand, when the analysis section length is not set at M2 frames or more in the judgment of step S35 (step S35; NO), the threshold value updating part 10 assumes the correction value as the value “C_Low” preset when the analysis section length is set at less than M2 frames (step S38).

The threshold value updating part 10 then uses the value calculated or set by the operations of steps S32 to S38 to perform the operation of calculating a new threshold value (step S39). Thereafter, the threshold value updating part 10 gives the calculated threshold value to the operation of step S18.

The threshold value Td according to the embodiment is specifically a threshold value which is updated each time the operation by the sound producing position detecting part 3 is started for the target frame, assuming Td=δ+λ×(residual power value as median) . . . (1) (step S39).

At this time, the constant λ is a preset fixed value and λ=1 is assumed experimentally, for example.

Here, the constant λ is used for the formula (1) in order to correct an influence of a transit section from a small residual power value to a large residual power value, and an influence of a transit section from a large residual power value to a small residual power value, respectively.

Specifically, when the median is calculated in the section ranging from a frame having a small residual power value and a frame having a large residual power value, the threshold value Td increases due to the residual power value and consequently the sound producing time may not be detected (may be erroneously detected) in the frame having a small residual power value. The constant λ is used for alleviating the possibility, and thus the constant λ is reduced so that the threshold value Td can be reduced. Thereby, the possibility of erroneously detecting the sound producing time in the frame having a small residual power value can be reduced.

Further, the value δ is calculated each time by the formula (2) except for the frame having the residual power value of “0” depending on the analysis section length through steps S36 to S38:

δ=(correction value set by one of steps S36 to S38)+(residual power values corresponding to all frames in analysis section/total number of frames in analysis section) (2)

Furthermore, the length (the number of frames) of the analysis section which is the threshold value for the correction value switching (see steps S36 to S38) is experimentally preset at M1=400 (frames) and M2=300 (frames) according to the embodiment, and further the correction value to be switched is assumed as C_High=0, C_middle=0.05, and C_Low=0.1 according to the embodiment.

The length (the number of frames) of the analysis section which is the threshold value for the correction value switching is set at “M1” or “M2” as described above because the longer the analysis section length (analysis time length) is, the smaller the correction value is (see steps S34 to S38), thereby alleviating an influence on the update of the threshold value Td of the time length of the analysis frame. For the parameter N, in the embodiment, the minimum detection sound length is assumed as the time corresponding to a sixteenth note (that is, 125 msec) and thus its value is set at “5”.

At last, the sound producing position correcting operation by the sound producing position correcting part 3C (see step S18 of FIG. 3) will be specifically described with reference to FIG. 5 and FIG. 6.

As shown in FIG. 5, at first the sound producing position correcting part 3C previously sets the minimum detection sound length by the sound producing position correcting operation through the user's operation or the like. The minimum detection sound length specifically employs the time corresponding to a sixteenth note (that is, 125 msec), for example.

Then, the sound producing position correcting part 3C calculates a time difference between a sound producing position candidate to be corrected for a current sound producing position (which will be called current sound producing position candidate below) and an immediately-previous sound producing position candidate (which will be called previous sound producing position candidate below) among the sound producing position candidates indicated by multiple items of candidate data Sp (whose differential value Sdiff is the threshold value Td or more, of course) input from the threshold value judging part 3B (step S180). Next, the sound producing position correcting part 3C confirms whether the obtained time difference is the minimum detection sound length (indicated by numeral T_{TH} in FIG. 6A) or more (step S181, see FIG. 6A).

Consequently, when the obtained time difference is the minimum detection sound length or more (step S181; YES), the sound producing position correcting part 3C judges that a sound producing position is included in the section of the frame corresponding to the previous sound producing position candidate, outputs the position as the sound producing signal Smp to the characteristic amount calculating part 4 (step S182, see numeral t₁ in FIG. 6B), and assumes the current sound producing position candidate at that time as the previous sound producing position candidate for the next sound producing position correcting operation (see numeral t₂ in FIG. 6B).

On the other hand, when the obtained time difference is less than the minimum detection sound length in the judgment of step S181 (step S181; NO), the sound producing position correcting part 3C then retrieves a sound producing position candidate where the time difference calculated by the operation of step S180 is the minimum detection sound length or more in comparison with the previous sound producing position candidate (step S183, see numerals t₁ to t₄ in FIGS. 6C and 6D).

When multiple sound producing position candidates can be retrieved (step S183; YES, see numerals t₁ to t₄ of FIGS. 6C and 6D), the sound producing position correcting part 3C then judges that the sound producing position is contained in the section of the frame corresponding to the sound producing position candidate having a corresponding maximum differential value Sdiff among the retrieved sound producing position candidates, and outputs the position as the sound producing signal Smp to the characteristic amount calculating part 4 (step S184, see numeral t₂ in FIG. 6E). Then, the sound producing position correcting part 3C assumes the sound producing position candidate corresponding to the temporal position which first exceeds the minimum detection sound length from the sound producing position obtained by the operation of step S184 as the previous sound producing position candidate for the next sound producing position correcting operation (step S185, see numeral t₅ in FIG. 6F). Then, the sound producing position correcting part 3C terminates the operation for one frame and proceeds to the operation of step S19 shown in FIG. 3.

### (B) Variant

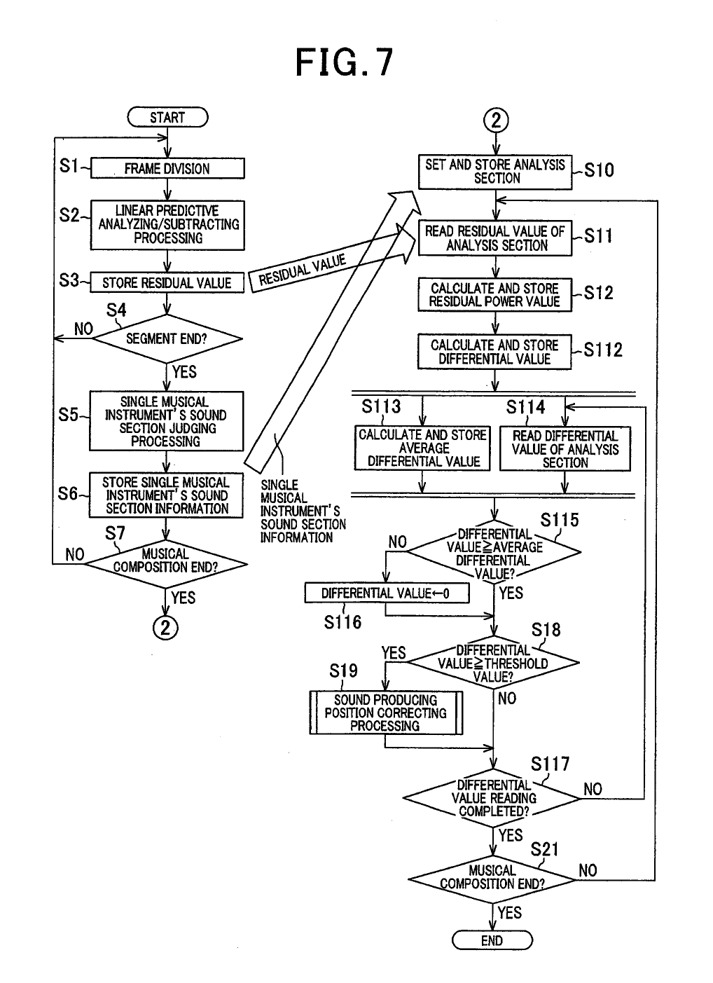

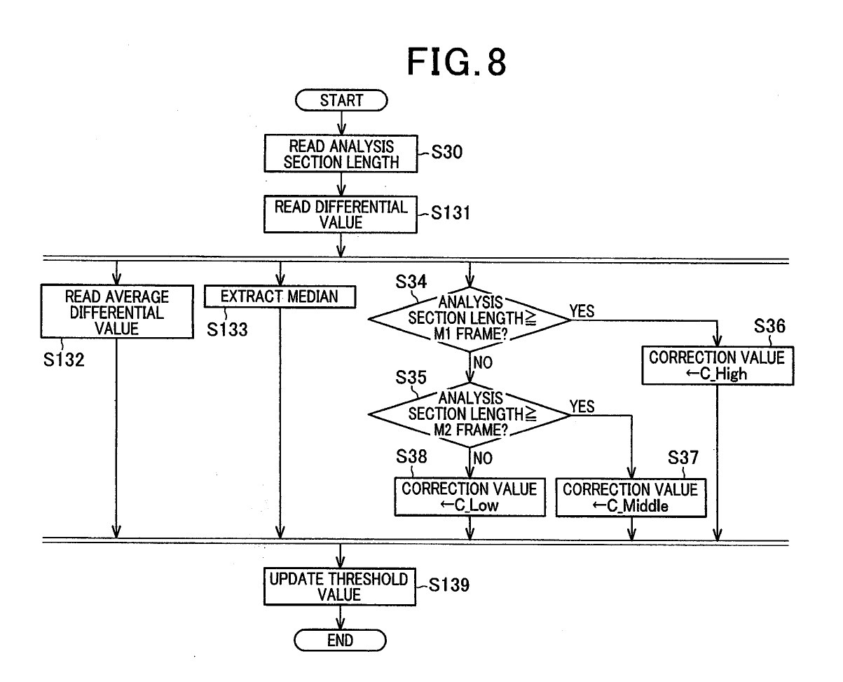

Next, a variant according to the present invention will be described with reference to FIG. 7 and FIG. 8. FIG. 7 is a flowchart showing an entire sound producing position detecting operation according to the variant along with the operations of the single musical instrument's sound section detecting part 2, and FIG. 8 is a flowchart showing a threshold value calculating operation performed by the threshold value updating part 10 according to the variant. In FIG. 7, the same processings as those by the sound producing position detecting operation according to the embodiment shown in FIG. 3 are denoted with the same step numbers, and a detailed explanation thereof is omitted. Further, in FIG. 8, the same processings as those by the threshold value calculating operation according to the embodiment shown in FIG. 4 are denoted with the same step numbers and a detailed explanation thereof is omitted.

In the embodiment described above, the threshold value Td is calculated based on the residual power value corresponding to the frame signal, and additionally the threshold value Td can be calculated based on the differential value Sdiff between the residual power value corresponding to the immediately-previous frame and the residual power value corresponding to the target frame.

In this case, instead of the formula (1), the threshold value Td is calculated using the formulas (1)′ and (2)′:

Td=δ+λ×(differential value Sdiff as median in analysis section) (1)′

δ=(correction value set by one of steps S36 to S38)+(differential value Sdiff corresponding to all frames in analysis section/total number of frames in analysis section) (2)′

The values of “δ” and “λ” in the formula (1)′ are similar to those in the formula (1).

Next, the sound producing position detecting operation and the threshold value calculating operation according to the variant will be described in detail.

At first, for the sound producing position detecting operation according to the variant, specifically the operations of steps S1 to S7 similar to the entire sound producing position detecting operation according to the embodiment shown in FIG. 3 are first performed in the single musical instrument's sound section detecting part according to the variant and the operations of steps S10 to S12 are performed in the sound producing position detecting part according to the variant as shown in FIG. 7.

Next, the sound producing characteristic amount detecting part according to the variant uses the calculated residual power value to calculate the differential value Sdiff for all the frames contained in one analysis section, and temporarily stores it in the memory (not shown) (step S112).

Thus, the sound producing characteristic amount detecting part according to the variant calculates an average differential value obtained by averaging the calculated differential values Sdiff for all the frames contained in one analysis section (step S113).

The sound producing characteristic amount detecting part according to the variant reads the differential value Sdiff per frame calculated by the operation of step S112 from the memory (not shown) (step S114), and compares the read differential value Sdiff with the average differential value calculated by the operation of step S113 (step S115) in parallel with the processing of step S113. Then, the sound producing characteristic amount detecting part according to the variant sets the differential value Sdiff for the fram at “0” (step S116) for the frame having the differential value Sdiff less than the average residual value (step S115; NO), and proceeds to the operation of subsequent step S18.

To the contrary, for the frame with the differential value Sdiff equal to or more than the average differential value in the judgment of step S115 (step S115; YES), the sound producing characteristic amount detecting part according to the variant outputs the differential value Sdif to the threshold value judging part according to the variant as it is.

Next, the threshold value judging part according to the variant which receives the value performs the operations of steps S18 and S19 similar to the threshold value judging part 3B according to the embodiment, and then the threshold value judging part according to the variant confirms whether the operations of steps S114 to S116 as well as S18 and S19 have been performed on all the frames contained in one analysis section set in step S10 (step S117). Then, when the operations of steps S114 to S5116 as well as S18 and S19 have not been terminated for all the frames (step S117; NO), the threshold value judging part according to the variant returns to step S114 for performing the operations of steps S114 to S5116 as well as S18 and S19 for the remaining frames in the analysis section.

On the other hand, when the operations of steps S114 to S116 as well as S18 and S19 have been performed on all the frames in the judgment of step S117 (step S117; YES), the threshold value judging part according to the variant performs the operation of step S21 similar to the threshold value judging part 3B according to the embodiment, and terminates the operations of the threshold value judging part and the threshold value updating part according to the variant.

Next, for the threshold value calculating operation according to the variant, specifically the threshold value updating part according to the variant first performs the operation of step S30 similar to the threshold value calculating operation according to the embodiment shown in FIG. 4 as shown in FIG. 8. Then, the threshold value updating part according to the variant reads the differential value Sdiff stored in step S112 of FIG. 7 for ±N frames about the target frame (step S131). Here, the parameter N indicating the number of frames read in the operation of step S131 is similar to the parameter N according to the embodiment.

Next, the threshold value updating part according to the variant performs the operation of reading the average differential value obtained in the operation of step S113 of FIG. 7 (step S132), the operation of extracting the median of the differential values Sdiff for ±N frames containing the target frame (step S133), and the operation of setting the correction value of the threshold value depending on the analysis section length in parallel (step S34 to S38), and then proceeds to the operation of step S39 described later.

Here, the operation of calculating the median in step S133 is specifically an operation of extracting the differential value Sdiff positioned on the center of the time series from the differential values Sdiff for ±N frames including the target frame.

Then, the threshold value updating part according to the variant uses the value calculated or set by the operations of steps S132 and S5133 as well as S34 to S38 to perform the operation of calculating anew threshold value (step S139). Thereafter, the threshold value updating part according to the variant gives the calculated threshold value to the operation of step S18.

Here, the threshold value Td according to the variant is specifically calculated by using the formulas (1)′ and (2)′.

In the operations according to the variant described above, the formulas (1)′ and (2)′ are used so that the two operations of calculating the residual power and calculating the differential value Sdiff are not required, thereby simplifying the structure of the sound producing position detecting part.

### EXAMPLE

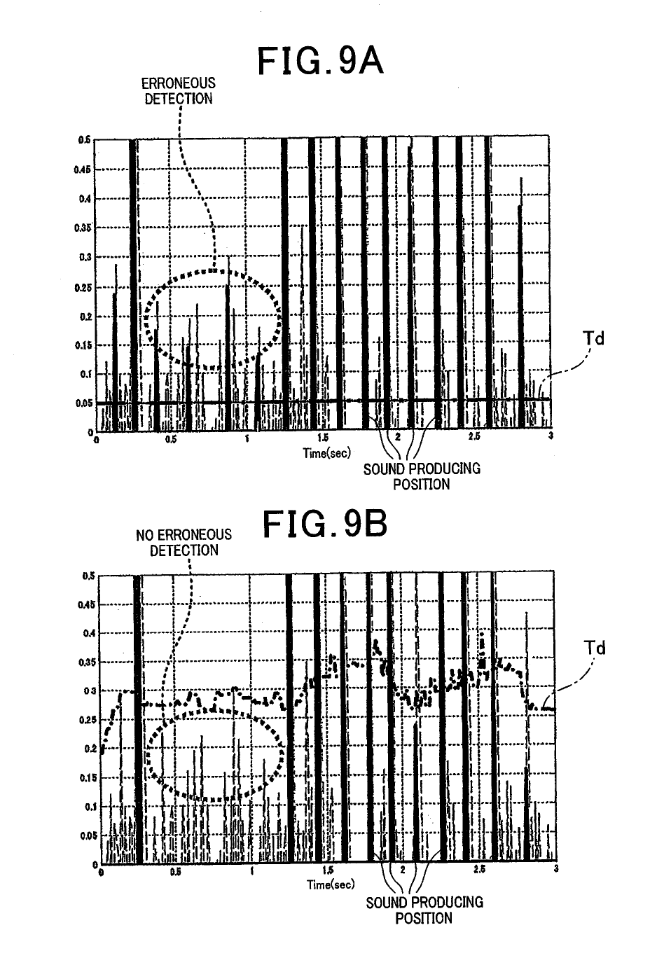

Next, actual experimental values are exemplified in FIG. 9 for an improvement in accuracy of the sound producing position detection by the operations of the sound producing position detecting part 3 according to the embodiment and variant described above. FIG. 9A is the first diagram exemplifying an accuracy of a conventional sound producing position detecting processing (the threshold value Td is constant irrespective of the speed of a musical composition), and FIG. 9B is a diagram exemplifying an accuracy of the sound producing position detecting processing according to the present invention. In FIGS. 9A and 9B, a dotted line indicates a change in threshold value Td (constant in FIG. 9A), a longitudinal solid line indicates a detected sound producing position, and a finely-changing dashed-line's waveform indicates a change in differential value Sdiff.

As is clear from FIGS. 9A and 9B, the sound producing position detecting operation according to the embodiment is performed so that an erroneous detection does not occur in the part indicated in a dashed-line's circle in FIG. 9A and thus it is confirmed that an accuracy of the sound producing position detection can be enhanced by 10% or more (about 15%).

As described above, through the operations of the sound producing position detecting part according to the embodiment, variant and example, the threshold value Td used for detecting a sound producing position of a musical instrument is calculated based on a differential value Sdiff of a residual power value for the liner predictive analyzing processing per frame, and compares the calculated threshold value Td with the differential value Sdiff to detect the sound producing position. This reflects the speed of the musical composition on the sound producing position detection since typically the higher the residual power value is, the faster the speed (tempo) of the musical composition is, and the lower the residual power value is, the slower the speed of the corresponding musical composition is. Thus, an accuracy of detecting the sound producing position of the musical instrument per frame is enhanced, thereby generating a sound producing signal Smp.

Therefore, the accuracy of detecting a sound producing position of a musical instrument is enhanced and consequently the rate of detecting the type of the musical instrument can be enhanced.

Since the differential value Sdiff is used to detect the sound producing position only when the differential value Sdiff is larger than its average value (see steps S15 to S18 of FIG. 3 or steps S115 and S5116 as well as S18 of FIG. 7), for example, the threshold value judging processing (step S18 of FIG. 3 or FIG. 7) is not performed on a section in which one sound is attenuating such as an ending part of the musical composition and thus the sound producing position can be detected more accurately.

Furthermore, when multiple sound producing position candidates are detected and a candidate having less than the minimum detection sound length is contained in a time interval between the sound producing position candidates, the sound producing position correcting part 3C detects that a sound producing position is contained in the section of the sound producing position candidate having the maximum differential value Sdiff among the sound producing position candidates contained in the time having the minimum detection sound length (see step S184 of FIG. 5), and the sound producing position candidates having a shorter time interval than the minimum detection sound length are excluded as error, and thus the sound producing position can be accurately detected.

The threshold value Td is calculated based on the formula (1) and the formula (2) (or the formula (1)′ and the formula (2)′) so that the smaller the differential value Sdiff is, the smaller the threshold value Td is, and the larger the differential value Sdiff is, the larger the threshold value Td is, thereby detecting the sound producing position more accurately.

Further, the threshold value Td is calculated by using the number of frames in one analysis section given to detect the sound producing position (see steps S34 to S38 of FIG. 4), thereby detecting the sound producing position more accurately. Specifically, the threshold Td is calculated based on the formula (2) (or the formula (2)′) so that the larger the number of frames is, the smaller the threshold value Td is, and the smaller the number of frames is, the larger the threshold value Td is, thereby detecting the sound producing position more accurately.

A program corresponding to the flowcharts shown in FIGS. 3 to 5 described above is recorded in an information recording medium such as flexible disk or hard disk or obtained via Internet or the like to be read and executed on a general-purpose computer, thereby using the computer as the sound producing position detecting part 3 according to the embodiment.

1-11. (canceled)

12. An information generating apparatus for generating type detection information used to detect a type of a musical instrument playing a musical composition, comprising:
a dividing unit which divides a musical composition signal corresponding to the musical composition into frame signals per preset unit time;
a power value calculating unit which performs a linear predictive analyzing processing on the divided frame signals and calculating a power value of a residual signal according to the linear predictive analyzing processing per frame signal;
a power value difference detecting unit which calculates a difference between the power value corresponding to one frame signal and the power value corresponding to the other frame signal position immediately before the one frame signal in the musical composition signal;
a threshold value calculating unit which calculates a threshold value for the difference used to detect a sound producing position of the musical instrument in the musical composition based on the calculated difference;
a sound producing position detecting unit which compares the calculated threshold value with each difference corresponding to each frame signal, and detects that the sound producing position is contained in a section of the frame signal having the larger difference than the threshold value; and
a generating unit which generates the type detection information corresponding to the section containing the sound producing position based on the detected sound producing position.

13. The information generating apparatus according to claim 12, further comprising:
an average value calculating unit which calculates an average value of the power values of the respective frame signals,
wherein the sound producing position detecting unit uses only the difference corresponding to the frame signal having the power value equal to or more than the calculated average value to compare with the calculated threshold value, and detects that the sound producing position is contained in the section of the frame signal having the larger difference than the threshold value.

14. The information generating apparatus according to claim 12,
wherein the sound producing position detecting unit comprises:
a candidate detecting unit which compares the calculated threshold value with each difference corresponding to each frame signal, and detects the frame signal having the larger difference than the threshold value as a sound producing position candidate frame signal; and
an interval detecting unit which, when the multiple sound producing position candidate frame signals are detected, detects a time interval between the respective sound producing position candidate frame signals,
wherein when a time interval shorter than a preset minimum sound length is contained in the detected time interval, it is detected that the sound producing position is contained in a section of the sound producing position candidate frame signal having the largest difference among the sound producing position candidate frame signals contained in the time having the minimum sound length.

15. The information generating apparatus according to claim 12,
wherein the calculating unit calculates the threshold value such that the smaller the detected difference is, the smaller the threshold value is.

16. The information generating apparatus according to claim 12,
wherein the calculating unit calculates the threshold value such that the larger the detected difference is, the larger the threshold value is.

17. The information generating apparatus according to claim 12,
wherein the threshold value calculating unit calculates the threshold value used to detect the sound producing position in a section of the one frame signal based on the difference corresponding to the other frame signal, and
the sound producing position detecting unit compares the calculated threshold value with the difference corresponding to the one frame signal.

18. The information generating apparatus according to claim 12,
wherein the threshold value calculating unit calculates the threshold value based on the calculated difference and the number of frame signals given to detect the sound producing position.

19. The information generating apparatus according to claim 18,
wherein the threshold value calculating unit calculates the threshold value such that the larger the number of frame signals is, the smaller the threshold value is.

20. The information generating apparatus according to claim 18,
wherein the threshold value calculating unit calculates the threshold value such that the smaller the number of frame signals is, the larger the threshold value is.

21. An information generating method for generating type detection information used to detect a type of a musical instrument playing a musical composition, comprising:
a process of dividing a musical composition signal corresponding to the musical composition into frame signals per preset unit time;
a process, of calculating a power value, of performing a linear predictive analyzing processing on the divided frame signals and calculating a power value of a residual signal according to the linear predictive analyzing processing per frame signal;
a process, of detecting a power value difference, of calculating a difference between the power value corresponding to one frame signal and the power value corresponding to the other frame signal positioned immediately before the one frame signal in the musical composition signal;
a process, of calculating a threshold value, of calculating a threshold value for the difference used to detect a sound producing position of the musical instrument in the musical composition based on the calculated difference;
a process, of detecting a sound producing position, of comparing the calculated threshold value with each difference corresponding to each frame signal, and detecting that the sound producing position is contained in a section of the frame signal having the larger difference than the threshold value; and
a process of generating the type detection information corresponding to the section containing the sound producing position based on the detected sound producing position.

22. An information recording medium in which an information generating program causing a computer to function as the information generating apparatus according to claim 12 is computer-readably recorded.
